(19) United States
(12) Patent Application Publication
(10) Pub. No.: US 2012/0179947 A1
(43) Pub. Date: Jul. 12, 2012

(54) COMMUNICATION APPARATUS, COMMUNICATION METHOD AND STORAGE MEDIUM FOR FLEXIBLE ERROR CORRECTION

(75) Inventor: Osamu KATO, Fukuoka (JP)

(73) Assignee: PANASONIC CORPORATION, Osaka (JP)

(21) Appl. No.: 13/331,461

(22) Filed: Dec. 20, 2011

(30) Foreign Application Priority Data
Jan. 11, 2011 (JP) 2011-003316

(51) Int. Cl. G06F 11/07; H04L 29/02

(52) U.S. Cl. 714/746; 370/474; 714/E11.023

(57) ABSTRACT

A communication apparatus performs communication with another communication apparatus through a communication path. The communication apparatus includes an encoder which is configured to generate B number of check packets from A number of information packets, a packet transmitter which is configured to transmit x number of the information packets and y number of the check packets, and a determination unit which is configured to determine the number of the information packets and the check packets to be transmitted by the packet transmitter to satisfy a condition of A≦x+y≦A+B in accordance with a state of the communication path.

### BACKGROUND

1. Technical Field

The present invention relates to a communication apparatus, a communication method, and a storage medium in which a communication program is stored.

2. Background Art

In an electronic apparatus in the related art, error detection or error correction for securing reliability of data is ordinarily performed in digital communication processing that is performed with an external communication apparatus and signal processing that is performed with respect to data obtained through the digital communication or data stored in a storage device. Whether or not an error occurs in data can be identified through the error detection. Further, whether or not an error occurs in data can be identified and further the data that has an error can be corrected through the error correction.

In error detection or error correction, there are kinds of block codes for converting codes having a unit length of k (k bits or the like) into code words having a unit length of n=m+k. These block codes are described as (n,k) codes or the like. The code words have the minimum hamming distance of d>1, that is, the code words are different from each other for at least a d unit. Using this redundancy, error detection or error correction is performed.

In error detection, an error in a d−1 unit can be detected for each code word. In the error correction, an error in [(d−1)/2] unit can be corrected for each code word (here, “[ ]” means a floor function).

One of the codes that is used for the error correction is a Forward Error Correction code (hereinafter, also referred to as an “FEC code”), and as one of FEC code, a Reed-Solomon code (hereinafter referred to as an “RS code”) is known. While the RS code is complicated to generate and decode, and thus requires processing time to some extent, the RS code has high error correction capability, and it is therefore applied to the error correction of terrestrial digital broadcasting, satellite communication, ADSL, CD, DCD, and QR codes, and the like. Further, in the RS code, symbols are indicated as symbol gathering after coding, and the error detection and error correction are performed in the symbol unit. Even if only any one bit in one symbol includes an error, it is recognized as an error of one symbol as a whole, and thus the RS code has the characteristic that it is strong against a burst error which is a bit error successively occurring. A code word of the RS code is indicated, for example, as an RS(n,k) code or simply, RS(n,k).

Further, in particular, error correction in the case where the position of an error is specified in advance is called an erasure correction. In the erasure correction, erasure can be corrected in the d unit for each code word.

As an example of an apparatus for performing the erasure correction, an image transmission apparatus is known, which can perform an error correction operation independently for each picture without causing the increase of transmission delay due to the addition of the error correction code and the local change of the redundancy or the increase of an operation amount (for example, see JP-A-2005-347927). This image transmission apparatus determines the number of information symbols and the number of check symbols of the error correction code, and based on this determination, generates a variable number of transmission symbols. Further, an image reception apparatus that receives the transmission symbols matches the process of the image transmission apparatus that selects one of the plurality of error correction codes and performs an error correction decoding process, based on the number of information symbols and the number of check symbols transmitted, to perform the error correction coding.

However, according to the technique of JP-A-2005-347927, since the image transmission apparatus flexibly sets the number of information symbols and the number of check symbols, it is required to prepare plural generating polynomials G(x), and thus the amount of memory consumed is increased.

### SUMMARY

The present invention has been made in consideration of the above-described circumstances, and an object of the present invention is to provide a communication apparatus, a communication method, and a storage medium in which a communication program is stored, which can reduce the amount of memory consumed while achieving a flexible error correction.

A communication apparatus as a transmission side for performing communication with another communication apparatus through a communication path, includes: an encoder which is configured to generate B number of check packets from A number of information packets; a packet transmitter which is configured to transmit x number of the information packets and y number of the check packets; and a determination unit which is configured to determine the number of the information packets and the check packets to be transmitted by the packet transmitter to satisfy a condition of A≦x+y≦A+B in accordance with a state of the communication path.

Further, a communication apparatus as a reception side for performing communication with another communication apparatus through a communication path, includes: a packet receiver which is configured to receive information packets and check packets; a packet number counter which is configured to count the number of the information packets and the check packets received by the packet receiver; and a decoder which is configured to perform erasure correction with respect to the information packets received by the packet receiver if the number of the packets counted by the packet number counter is equal to or larger than the number of the information packets that are used when the check packets are generated.

According to the configuration, it is possible to reduce the mount of memory consumed while achieving a flexible error correction.

### BRIEF DESCRIPTION OF THE DRAWINGS

In the accompanying drawings:

FIG. 1 is a block diagram illustrating an example of the configuration of a communication system according to a first embodiment of the invention;

FIG. 2 is a diagram illustrating an example of the configuration of an RS code according to the first embodiment of the invention;

FIG. 3 is a diagram illustrating FEC encoding according to the first embodiment of the invention;

FIG. 4 is a table illustrating an example of the relationship between an FEC coding rate of a transmission packet and a symbol to be transmitted to a communication path according to the first embodiment of the invention;

FIG. 5 is a table illustrating FEC decoding according to the first embodiment of the invention;

FIG. 6 is a flowchart illustrating an example of an operation when an FEC decoder performs a first FEC decoding process according to the first embodiment of the invention;

FIG. 7 is a flowchart illustrating an example of an operation when an FEC decoder performs a second FEC decoding process according to the first embodiment of the invention;

FIG. 8 is a block diagram illustrating an example of the configuration of a communication system according to a second embodiment of the invention; and

FIG. 9 is a block diagram illustrating an example of the configuration of a communication system according to a third embodiment of the invention.

### DETAILED DESCRIPTION

Hereinafter, embodiments of the present invention will be described using the drawings.

As a communication apparatus according to embodiments of the invention, a communication apparatus that performs communication by wire, such as a wired LAN, coaxial cable, and power line, or a communication apparatus that performs communication wirelessly, such as cellular communication, a wireless LAN, and Bluetooth (registered trademark), may be considered.

Further, the communication apparatus according to the embodiments of the invention is very suitable for packet transmission using a communication path which has limiting conditions in that the packet amount transmitted to the communication path is made as small as possible. The communication apparatus that performs the packet transmission may be a television conference system, a monitoring camera image transmission system, a system that performs downloading/uploading of image data, a remote teaching system, and the like. Further, the communication apparatus that performs the packet transmission is very suitable for a communication apparatus that performs communication using a communication path that has a relatively high packet error rate such as a wireless communication path.

(Specific Operation of Error Correction and Erasure Correction)

The communication apparatus according to the embodiments of the invention performs error correction, particularly, erasure correction. Before describing the respective embodiments, a specific operation method of the error correction and erasure correction will be described.

Here, it is assumed that data is transmitted from a transmission apparatus that is one communication apparatus to a reception apparatus that is one communication apparatus, and the code word of the RS code is RS(15, 7), that is, k=7, m=8, and n=15. Further, it is assumed that one symbol is of 8 bits. Data of RS(15, 7) includes information data D₀ to D₆ to be actually sent and parity data P₀ to P₇ for performing the check.

First, the transmission apparatus and the reception apparatus prepare and maintain the following 8th order generating polynomial G(x).

G(x)=(x+α⁷)(x+α⁶)(x+α⁵)(x+α⁴)(x+α³)(x+α²)(x+α¹)(x+α⁰) [Equation 1]

The transmission apparatus determines the parity data P₀ to P₇ to form the following equation based on the information data D₀ to D₆.

$${x}^{8} \cdot {\sum }_{i = 0}^{6} {x}^{i} \cdot {D}_{i} mod G ( x ) = {\sum }_{i = 0}^{7} {x}^{i} \cdot {P}_{i} \qquad [ Equation 2 ]$$

Next, it is assumed that D₆=W₁₄, D₅=W₁₃, . . . , D₀=W₈, P₇=W₇, P₆=W₆, . . . , P₀=W₀. W₀ to W₁₄ denote transmission symbols. If W(x) is defined as follows from Equation 2, W(x) can be divided by G(x).

$$\begin{matrix}W ( x ) = {\sum }_{i = 0}^{14} {x}^{i} \cdot {W}_{i} \\ = {W}_{14} {x}^{14} + {W}_{13} {x}^{13} + … + {W}_{1} x + {W}_{0}\end{matrix} \qquad [ Equation 3 ]$$

Accordingly, if W(x) is indicated as W(x)=G(x)·A(x)+B(x), B(x) becomes B(x)=0. By substituting x=a⁰, x=a¹, x=a², . . . , x=a⁷ in both sides of Equation 3, the following equation can be derived.

$$( \begin{matrix}W ( {α}^{0} ) = G ( {α}^{0} ) A ( {α}^{0} ) = 0 \times A ( {α}^{0} ) = 0 \\ W ( {α}^{1} ) = G ( {α}^{1} ) A ( {α}^{1} ) = 0 \times A ( {α}^{1} ) = 0 \\ … \\ W ( {α}^{7} ) = G ( {α}^{7} ) A ( {α}^{7} ) = 0 \times A ( {α}^{7} ) = 0\end{matrix} \qquad [ Equation 4 ]$$

As described above, with respect to the transmission symbols W₀ to W₁₄ transmitted by the transmission apparatus, an equation to be satisfied exists (the limiting conditions of the transmission apparatus).

On the other hand, the reception apparatus receives the reception symbols R₀ to R₁₄ from the transmission apparatus. Between the transmission symbols and the reception symbols, the following relationship exists.

$$( \begin{matrix}{W}_{14} = {E}_{14} = {R}_{14} \\ {W}_{13} = {E}_{13} = {R}_{13} \\ … \\ {W}_{0} = {E}_{0} = {R}_{0}\end{matrix} \qquad [ Equation 5 ]$$

That is, the following equation is obtained.

$$R ( x ) = {\sum }_{i = 0}^{14} {x}^{i} ( {W}_{i} + {E}_{i} ) = {\sum }_{i = 0}^{14} {x}^{i} \cdot {R}_{i} \qquad [ Equation 6 ]$$

Eᵢ represents error symbols that overlap the respective transmission symbols on the communication path.

Here, if Equation 7 is defined as follows,

$$\{ \begin{matrix}E ( x ) = {\sum }_{i = 0}^{14} {x}^{i} \cdot {E}_{i} = {E}_{14} {x}^{14} + {E}_{13} {x}^{13} + … + {E}_{1} x + {E}_{0} \\ R ( x ) = {\sum }_{i = 0}^{14} {x}^{i} \cdot {R}_{i} = {R}_{14} {x}^{14} + {R}_{13} {x}^{13} + … + {R}_{1} x + {R}_{0}\end{matrix} \qquad [ Equation 7 ]$$

Equation 6 can be represented as follows.

W(x)+E(x)=R(x)

By substituting x=a⁰, x=a¹, x=a², . . . , x=a⁷ in both sides of Equation 7, the following equation can be derived by using a syndrome Sᵢ.

$$( \begin{matrix}W ( {α}^{0} ) + E ( {α}^{0} ) = E ( {α}^{0} ) = R ( {α}^{0} ) = {S}_{0} \\ W ( {α}^{1} ) + E ( {α}^{1} ) = E ( {α}^{1} ) = R ( {α}^{1} ) = {S}_{1} \\ … \\ W ( {α}^{7} ) + E ( {α}^{7} ) = E ( {α}^{7} ) = R ( {α}^{7} ) = {S}_{7}\end{matrix} \qquad [ Equation 8 ]$$

That is, the reception apparatus can inherently determine 8 syndromes based on error symbols (E(x)) that overlap the transmission symbols on the communication path.

Further, by substituting x=a⁰, x=a¹, x=a², . . . , x=a⁷ in E(x) from Equations 7 and 8, the following results can be obtained.

$$( \begin{matrix}E ( {α}^{0} ) = {E}_{14} {α}^{0} + {E}_{13} {α}^{0} + … + {E}_{1} {α}^{0} + {E}_{0} {α}^{0} = {S}_{0} \\ E ( {α}^{1} ) = {E}_{14} {α}^{14} + {E}_{13} {α}^{13} + … + {E}_{1} {α}^{1} + {E}_{0} {α}^{0} = {S}_{1} \\ E ( {α}^{2} ) = {E}_{14} {α}^{28} + {E}_{13} {α}^{26} + … + {E}_{1} {α}^{2} + {E}_{0} {α}^{0} = {S}_{2} \\ … \\ E ( {α}^{7} ) = {E}_{14} {α}^{98} + {E}_{13} {α}^{91} + … + {E}_{1} {α}^{7} + {E}_{0} {α}^{0} = {S}_{7}\end{matrix} \qquad [ Equation 9 ]$$

If it is assumed that among the respective error symbols Eᵢ, the number of error symbols Eᵢ that satisfy Eᵢ≠0 (that are not 0) is P, and i=L(0), L(1), . . . , (P-1), the following equation is formed from Equation 9. At this time, an asterisk “*” denotes multiplication.

$$[ \begin{matrix}{α}^{0} & {α}^{0} & … & {α}^{0} & {α}^{0} \\ {α}^{L ( 0 )} & {α}^{L ( 1 )} & … & {α}^{L ( P - 2 )} & {α}^{L ( P - 1 )} \\ {α}^{2 L ( 0 )} & {α}^{2 L ( 1 )} & … & {α}^{2 L ( P - 2 )} & {α}^{2 L ( P - 1 )} \\ … & & & & \\ {α}^{( P - 2 ) * L ( 0 )} & {α}^{( P - 2 ) * L ( 1 )} & … & {α}^{( P - 2 ) * L ( P - 2 )} & {α}^{( P - 2 ) * L ( P - 1 )} \\ {α}^{( P - 1 ) * L ( 0 )} & {α}^{( P - 1 ) * L ( 1 )} & … & {α}^{( P - 1 ) * L ( P - 2 )} & {α}^{( P - 1 ) * L ( P - 1 )}\end{matrix} ] [ \begin{matrix}{E}_{L ( 0 )} \\ {E}_{L ( 1 )} \\ {E}_{L ( 2 )} \\ … \\ {E}_{L ( P - 2 )} \\ {E}_{L ( P - 1 )}\end{matrix} ] = [ \begin{matrix}{S}_{0} \\ {S}_{1} \\ {S}_{2} \\ … \\ {S}_{P - 2} \\ {S}_{P - 1}\end{matrix} ] \qquad [ Equation 10 ]$$

As for RS(15, 7), it is possible to perform erasure correction in the case of P=0 to 8, that is, in the case where the maximum number of error symbols is 8. On the other hand, in the case of P≧9, that is, if the number of error symbols is equal to or larger than 9, it is not possible to perform erasure correction.

For example, if it is assumed that an error occurs in positions where i=5, 8, and 13, the following equation is formed.

$$( \begin{matrix}{E}_{13} {α}^{0} + {E}_{8} {α}^{0} + {E}_{5} {α}^{0} = {S}_{0} \\ {E}_{13} {α}^{13} + {E}_{8} {α}^{8} + {E}_{5} {α}^{5} = {S}_{1} \\ {E}_{13} {α}^{26} + {E}_{8} {α}^{16} + {E}_{5} {α}^{10} = {S}_{2}\end{matrix} \qquad [ Equation 11 ]$$

The reception apparatus can recognize values of syndromes S₀, S₁, and S₂ by the reception symbols, and can also recognize the value of a from the definition equation of the generating polynomial G(x). Accordingly, if the erasure symbol position (the value of i) that is the position in which the error occurs can be recognized, the values of the respective error symbols E₅, E8, and Ecan be calculated to perform erasure correction.

### First Embodiment

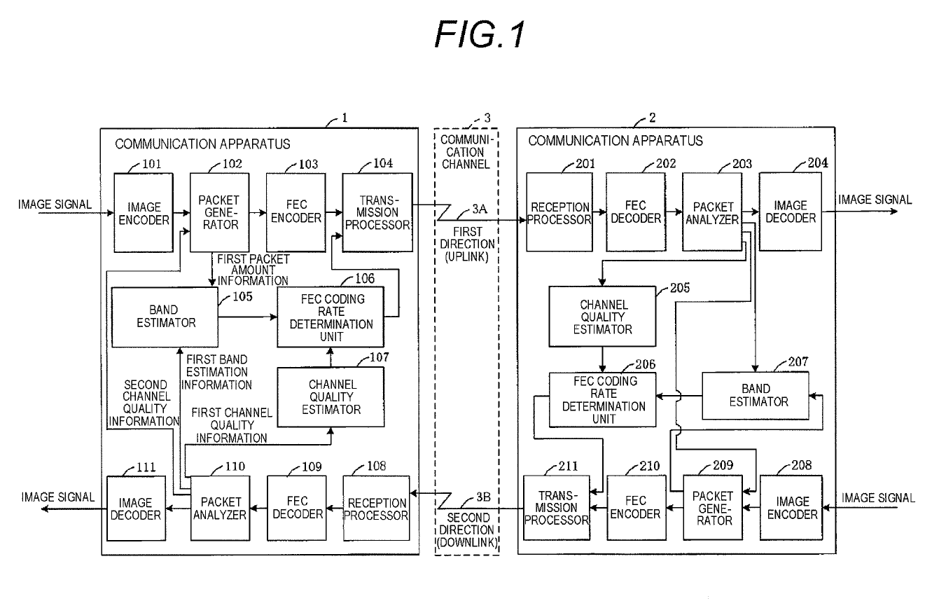

FIG. 1 is a block diagram illustrating an example of the configuration of a communication system according to a first embodiment of the invention. In the communication system illustrated in FIG. 1, a communication apparatus 1 is connected to a communication apparatus 2 through a communication path 3.

The communication path 3 broadly includes communication channels including a wired channel, such as a power line, a wired LAN, or the like, and a wireless channel, such as cellular communication, a wireless LAN, or the like. Further, it is considered that the communication path 3 includes a base station, a core network, the Internet, or the like. Further, the communication path 3 includes a first communication path 3A through which data is transmitted in a direction (first direction) that is from the communication apparatus 1 to the communication apparatus 2 and a second communication path 3B through which data is transmitted in a direction (second direction) that is from the communication apparatus 2 to the communication apparatus 1.

The communication apparatus 1 includes an image encoder 101, a packet generator 102, an FEC encoder 103, a transmission processor 104, a band estimator 105, an FEC coding rate determination unit 106, a channel quality estimator 107, a reception processor 108, an FEC decoder 109, a packet analyzer 110, and an image decoder 111.

The image encoder 101 encodes an image signal received from an external device or an image signal output from a memory not illustrated, and generates an image code. The image code is an example of an information symbol. Here, a known method is used as the image signal encoding method. In the case of encoding the image signal at a variable rate, the number of information packets generated for a predetermined time is varied.

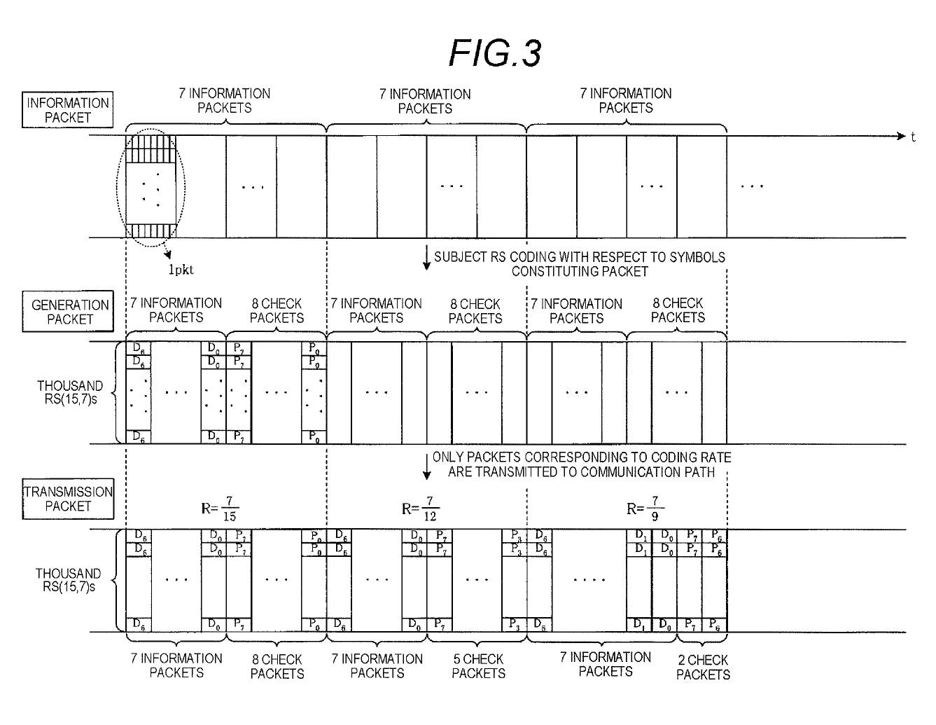

The packet generator 102 generates a packet (information packet) that includes an information symbol as an image code (see FIG. 3 to be described later). Further, the packet generator 102 generates a packet (control packet) that includes second channel quality information as information that indicates the result of quality analysis of the second communication path 3B analyzed by the packet analyzer 110. Information on the amount of packets generated by the packet generator 102 is sent to the band estimator 105 as first packet amount information.

The FEC encoder 103 encodes by FEC (FEC-encodes) the information symbol constituting the information packet from the packet generator 102, and generates an FEC code of a fixed length. When the FEC encoding is performed, Equations 1 to 4 as described above are taken into account. The FEC code is composed of an information symbol and a check symbol, and may be an RS code. The details of the FEC encoding will be described later. Hereinafter, the packet encoded by the FEC encoder 103 is also referred to as a generation packet (see FIG. 3 to be described later).

The transmission processor 104 transmits all parts or some parts of the generation packet to the first communication path 3A based on the FEC coding rate R of the transmission packet determined by the FEC coding rate determination unit 106. Specifically, the transmission processor limits the transmission of the check symbol according to the FEC coding rate R of the transmission packet, and transmits the packet that includes at least some parts of the information symbol and the check symbol included in the FEC code as the transmission packet. Hereinafter, the packet transmitted by the transmission processor 104 is also referred to as a transmission packet (see FIG. 3 to be described later). At this time, even in the case where the transmission side has a plurality of generating polynomials, it is not necessary for the transmission processor 104 to send the information of the FEC coding rate R of the transmission packet to the first communication path 3A. That is, if the reception side is aware of which generating polynomial uses the transmission side even in a state where the communication apparatus 2 does not grasp the FEC coding rate of the transmission packet of the communication apparatus 1, that is, the number of check symbols of the FEC code included in the transmission packet, the error correction processing is possible according to the embodiment of the invention. Accordingly, in the embodiment of the invention, the FEC coding rate and the number of check symbols are not transmitted, and further, in the case where one kind of generating polynomial is used on the transmission side, it is not necessary to transmit to the reception side which generating polynomial has been used. In this case, the FEC coding rate and the number of check symbols may also be transmitted as needed.

The band estimator 105 estimates the communication band (throughput, transmission speed, and the like) of the first communication path 3A that can be allocated to the communication apparatus 1 based on the first packet amount information from the packet generator 102 and the first band estimation information from the packet analyzer 110. The first band estimation information is information that is the basis of the band estimation of a Round Trip Time (RTT) that is obtained by the TCP protocol.

The FEC coding rate determination unit 106 determines the FEC coding rate R of the transmission packet based on at least either of the band that can be allocated to the communication apparatus 1 estimated by the band estimator 105 and the channel quality of the first communication path 3A estimated by the channel quality estimator 107. That is, the FEC coding rate determination unit 106 determines the FEC coding rate R of the transmission packet in accordance with a state of the first communication path 3A. The FEC coding rate R of the transmission packet represents the rate of the number of information packets to the sum (total packet number) of the number of information packets and the number of check packets which are transmitted by the transmission processor 104. The FEC coding rate of the generation packet is fixed, and the FEC coding rate R of the transmission packet is variable.

For example, as the allocable band of the first communication path 3A that is estimated by the band estimator 105 becomes wider, or as the channel quality of the first communication path 3A that is estimated by the channel quality estimator 107 becomes better, the FEC coding rate R of the transmission packet is determined as a larger value. On the other hand, as the allocable band of the first communication path 3A that is estimated by the band estimator 105 becomes narrower, or as the channel quality of the first communication path 3A that is estimated by the channel quality estimator 107 becomes worse, the FEC coding rate R of the transmission packet is determined as a smaller value.

The channel quality estimator 107 estimates the channel quality of the first communication path 3A based on the first channel quality information from the packet analyzer 110. The first channel quality information is information that indicates the channel quality of the first communication path 3A when the packet is transmitted to the communication apparatus 2 through the first communication path 3A, and includes information on the packet error rate, the transmission speed, and the like, of the packet transmitted over the first communication path 3A. The first channel quality information is information that is the basis of the channel quality estimation of the current first communication path 3A.

The reception processor 108 receives a packet from the second communication path 3B. Hereinafter, the packet received by the reception processor 108 may be referred to as a received packet. The received packet includes the FEC code. In an ideal case where channel errors do not overlap each other in the communication path in receiving the packet from the communication apparatus 2, the received packet is the same as the transmission packet of the communication apparatus 2.

The FEC decoder 109 decodes by FEC (FEC-decodes) the received packet. In performing the FEC decoding, Equations 5 to 11 as described above are considered. The details of the FEC decoding will be described later. Hereinafter, the packet FEC-decoded by the FEC decoder 109 is also referred to as a decoded packet. Further, the FEC decoder 109 counts the number of symbols (the total number of information symbols and check symbols) of the same FEC code included in the received packet.

Here, the same FEC code means that even if the number of symbols actually transmitted to the communication path is any number in the range of 7 to 15 in the case where the encoding has been performed with RS(15, 7), the transmitted symbol thereof is the symbol included in the same RS(15, 7).

The packet analyzer 110 analyzes the decoded packet. Specifically, the packet analyzer 110 extracts information that is the basis of the quality estimation of the second communication path 3B, such as the packet error rate and transmission speed of the decoded packet. The extracted information is sent to the packet generator 102 as the second channel quality information. Further, the packet analyzer 110 extracts the first channel quality information included in the decoded packet. The extracted first channel quality information is sent to the first channel quality estimator 107. Further, the packet analyzer 110 extracts information that is the basis of band estimation such as RTT or the like obtained by a TCP protocol. The extracted information is sent to the band estimator 105 as the first band estimation information.

The image decoder 111 decodes the image code that is the information symbol included in the information packet from the packet analyzer 110, and obtains an image signal. Here, a known method is used as the image signal decoding method.

The communication apparatus 2 includes a reception processor 201, an FEC decoder 202, a packet analyzer 203, an image decoder 204, a channel quality estimator 205, an FEC coding rate determination unit 206, a band estimator 207, an image encoder 208, a packet generator 209, an FEC encoder 210, and a transmission processor 211.

The reception processor 201 has the same configuration and function as the reception processor 108, and receives a packet from the first communication path 3A. Hereinafter, the packet received by the reception processor 201 is also called a received packet.

The FEC decoder 202 has the same configuration and function as the FEC decoder 109, and FEC-decodes the received packet. Hereinafter, the packet FEC-decoded by the FEC decoder 202 is also called a decoded packet. Further, the FEC decoder 1202 counts the number of symbols of the same FEC code included in the received packet.

The packet analyzer 203 has the same configuration and functions as the packet analyzer 110, and analyzes the decoded packet. Specifically, the packet analyzer 203 extracts information that is the basis of the quality estimation of the first communication path 3A, such as the packet error rate and transmission speed of the decoded packet. The extracted information is sent to the packet generator 209 as the first channel quality information. Further, the packet analyzer 203 extracts the second channel quality information included in the decoded packet. The extracted second channel quality information is sent to the channel quality estimator 205. Further, the packet analyzer 203 extracts information that is the basis of the band estimation such as RTT or the like obtained by the TCP protocol. The extracted information is sent to the band estimator 207 as the second band estimation information.

The image decoder 204 has the same configuration and functions as the image decoder 111, and decodes the image code that is the information symbol included in the information packet from the packet analyzer 203, and obtains an image signal.

The channel quality estimator 205 has the same configuration and function as the channel quality estimator 107, and estimates the channel quality of the second communication path 3B based on the second channel quality information from the packet analyzer 203. The second channel quality information is information that indicates the channel quality of the second communication path 3B when the packet is transmitted to the communication apparatus 1 through the second communication path 3B, and includes information on the packet error rate, the transmission speed, and the like, of the packet transmitted over the second communication path 3B. The second channel quality information is information that is the basis of the channel quality estimation of the current second communication path 3B.

The FEC coding rate determination unit 206 has the same configuration and function as the FEC coding rate determination unit 106, and determines the FEC coding rate R of the transmission packet based on at least either of the band that can be allocated to the communication apparatus 2 estimated by the band estimator 207 and the channel quality of the second communication path 3B estimated by the channel quality estimator 205.

The band estimator 207 has the same configuration and function as the band estimator 105, and estimates the communication band (throughput, transmission speed, and the like) of the second communication path 3B that can be allocated to the communication apparatus 2 based on the second packet amount information from the packet generator 209 and the second band estimation information from the packet analyzer 203.

The image encoder 208 has the same configuration and functions as the image encoder 101, and encodes an image signal received from an external device or an image signal output from a memory not illustrated, and generates an image code.

The packet generator 209 has the same configuration and functions as the packet generator 102, and generates a packet (information packet) that includes an information symbol as an image code. Further, the packet generator 209 generates a packet (control packet) that includes first channel quality information from the packet analyzer 203. The amount of packet generated by the packet generator 209 is sent to the band estimator 207 as second packet amount information.

The FEC encoder 210 has the same configuration and function as the FEC encoder 103, and FEC-encodes the information symbol constituting the information packet from the packet generator 209 and generates an FEC code of a fixed length. Hereinafter, the packet that is encoded by the FEC encoder 210 is called a generation packet.

The transmission processor 211 has the same configuration and function as the transmission processor 104, and transmits all parts or some parts of the generation packet to the second communication path 3B based on the FEC coding rate R of the transmission packet determined by the FEC coding rate determination unit 206. Hereinafter, the packet transmitted by the transmission processor 211 is also called a transmission packet. At this time, the transmission processor 211 does not transmit the information of the FEC coding rate R of the transmission packet to the second communication path 3B.

In the following description, since the operation of the communication apparatus 1 is the same as the operation of the communication apparatus 2, the operation of the communication apparatus 1 is exemplified with respect to the operation regarding the transmission, and the operation of the communication apparatus 2 is exemplified with respect to the operation regarding the reception. Further, it is assumed that an RS code is used as the FEC code.

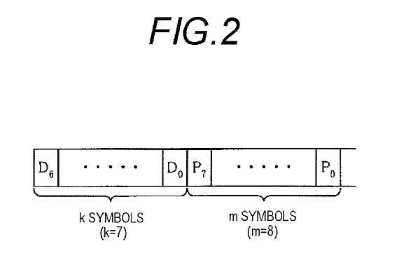

Further, in order to reduce the amount of memory consumed, the FEC generating polynomial of the generation packet is limited to a small number of kinds as far as possible. For example, it is preferable that only one kind of RS(15, 7) code is used or only two kinds of RS(15, 7) code and RS(31, 15) code are used. In this embodiment, it is assumed that only one kind of RS(15, 7) code, in which the number of information symbols is 7 and the number of check symbol is 8, is used. That is, it is assumed that the RS code as illustrated in FIG. 2 is used.

Next, FEC encoding will be described in detail.

FIG. 3 is a diagram illustrating FEC encoding.

The image encoder 101 encodes the image signal, and the packet generator 102 converts the encoded image signal into information packet. Here, “1 pkt” in FIG. 3 represents information packet for one packet, and for example, corresponds to 1000 information symbols (8000 bits). Here, information packets for 7 packets are partitioned. Further, 8 bits correspond to one symbol. In this embodiment, since the data size of one packet is large, the packet is divided into symbols, and the RS encoding is performed in the unit of one symbol. However, it is also possible to perform the RS encoding in the unit of one packet without dividing the packet into the symbols.

Then, the FEC encoder 103 performs FEC encoding by adding check packets for 8 packets with respect to 7 information packets to correspond to RS(15, 7), here, 15 packets (7 information packets and 8 check packets) are partitioned, and 15 packets correspond to 1000 RS(15, 7) codes.

As described above, the FEC encoder 103 generates first to seventh information packets and eighth to fifteenth check packets regardless of the communication band of the first communication path 3A that is allocable to the communication apparatus 1 or the channel quality of the first communication path 3A. In this embodiment, since the number of information symbols k and the number of check symbols m of the RS code are fixed, the number of packets that are generated by the FEC encoder 103 is constant.

Then, the transmission processor 104 transmits the transmission packet according to the FEC coding rate R of the transmission packet. In FIG. 3, it is exemplified that the FEC coding rate R of the transmission packet is R=7/15, R=7/12, and R=7/9, respectively. In the case of R=7/15, the total number of 15 transmission packets including 7 information packets and 8 check packets are transmitted to the first communication path 3A. In the case of R=7/12, the 12 transmission packets including 7 information packets and 5 check packets are transmitted to the first communication path 3A. In the case of R=7/9, the 9 transmission packets including 7 information packets and 2 check packets are transmitted to the first communication path 3A.

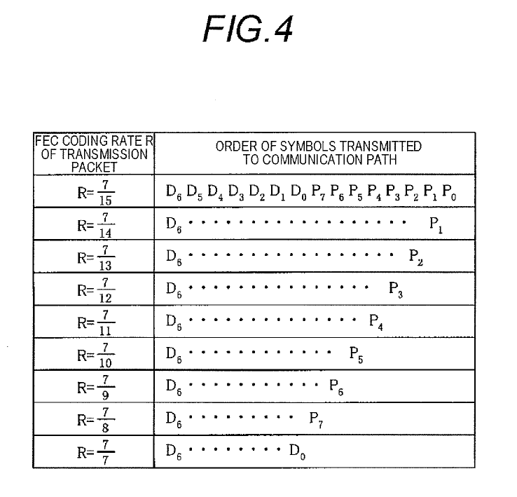

In this case, the FEC coding rate R of the transmission packet, as indicated in FIG. 4, is changed in the range of R=7/15 to 7/7. That is, if the RS code is generalized and indicated with the RS code RS(m+k,k), the FEC coding rate R of the transmission packet can take plural patterns, that is, m+1 kinds of values in the range of R=k/(m+k) to 1. FIG. 4 is a table indicating the FEC coding rates R of the transmission packets and the order of symbols transmitted to the communication path 3.

As indicated in FIG. 4, the transmission processor 104 outputs the packets in the order of outputs from the FEC encoder 103, and thus the coding rate R can be simply changed by canceling the check packets output thereafter.

7 information packets on the top, 15 generation packets in the intermediate, and 15, 12, or 9 transmission packets at the bottom are indicated at the same scale on the time axis in FIG. 3, and they indicate that the transmission speeds of the respective packets are different from each other. That is, if the number of transmission packets transmitted by the communication apparatus 1 is large, the band use rate of the first communication path 3A is heightened, while if the number of packets transmitted by the communication apparatus 1 is small, the band use rate of the first communication path 3A is lowered. Accordingly, as the number of packets transmitted by the communication apparatus 1 becomes smaller, the communication band that can be allocated to another communication apparatus connected to the first communication path 3A is increased, and thus the network resources can be effectively utilized.

Further, unlike what has been described above, the transmission speeds of respective packets may be set to be equal to each other. In the case where the transmission speeds are set to be equal to each other, if the number of packets transmitted by the communication apparatus 1 is large, the band of the first communication path 3A is used for a long time, while if the number of packets transmitted by the communication apparatus 1 is small, the band of the first communication path 3A is used for a short time. Accordingly, as the number of packets transmitted by the communication apparatus 1 becomes smaller, the communication band that is allocable to another communication apparatus connected to the first communication path 3A is increased, and thus the network resources can be effectively utilized.

According to the FEC encoding as described above, the generation packet can be generated by one or a small number of kinds of RS codes as far as possible. That is, one or a small number of generating polynomials G(x) as far as possible may be used when the generation packets are generated, and the complexity of operation can be avoided, such as it is not necessary to transfer control information on which error correction code is executed from the transmission side to the reception side, or the like. Further, since the transmission packet actually transmitted through the communication path 3 is determined based on the FEC coding rate R, the number of transmission packets (the number of check packets) can be flexibly set according to an empty state of the band of the communication path 3 or the communication environment of the channel quality of the communication path 3.

That is, since the plurality of FEC coding rates R can be determined in one generating polynomial G(x), a communication system that varies the FEC coding rate R without preparing a plurality of generating polynomials G(x) is realized.

Next, FEC decoding will be described in detail.

In the FEC decoding, error correction of the received packet is performed, and if the error correction succeeds, the transmission packet transmitted by the communication apparatus 1 is restored to the original data. In the embodiment, an erasure correction is mainly performed as an error correction. Hereinafter, erasure correction will be mainly described.

The FEC decoder 202 of the communication apparatus 2 restores a lost packet by erasure correction with respect to a packet loss. The packet loss includes both a packet error in which an error occurs even though the packet arrives at the reception side and a packet loss in which the packet does not arrive at the reception side. Further, as regards a specified operation that is commonly executed for plural RS codes in the erasure correction, the operation is performed only with respect to one initial RS code, but the common operation is omitted with respect to the remaining RS codes.

For example, if an error occurs in one symbol among the RS codes in which one packet is composed of 1000 symbols, the error is always detected with respect to the other 999 symbols of the packet in which the symbol exists. For example, if an error occurs in a certain symbol of the fifth packet, the whole fifth packet is detected as the error, and thus the 1000 symbols of the fifth packet are all detected as errors. Accordingly, if an error symbol position (erasure position) of one RS code is detected, the remaining 999 RS codes are determined as erasure positions, and thus the specified operation process (inverse matrix calculation) that repeats 999 times can be omitted.

In the case of RS(15, 7) as described above (Equation 10), when 8 packet losses occur, the matrix in the leftmost parenthesis becomes an 8×8 matrix, and the operation amount becomes greatest. In the packet communication, the packets are successively detected as errors in connection with each other as described above, the results of operation of the determinant in the leftmost parenthesis (in Equation 10), that is, the results of operation of an inverse matrix of the determinant in the leftmost parenthesis that are necessary when the erasure correction is performed, are always the same. Accordingly, if this operation is performed with respect to the initial RS code, the same inverse matrix can be used for the operation such as the RS code thereafter, and thus the operation processing can be omitted.

Further, in the packet communication, if the erasure position is uncertain, a typical error correction is performed with respect to an initial RS code of the successive RS codes, and the erasure correction is performed with respect to the RS codes thereafter since the erasure position can be specified with respect to the RS codes thereafter.

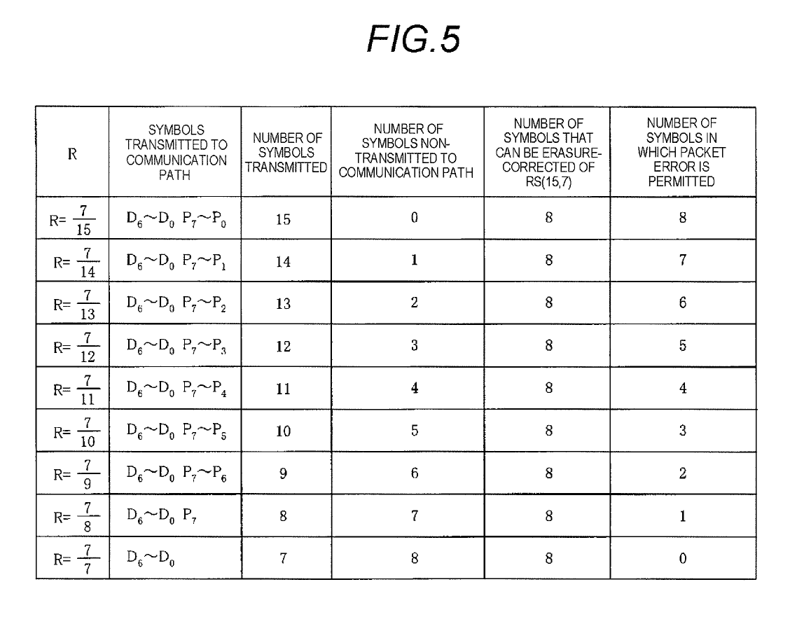

FIG. 5 is a table indicating the FEC decoding. As indicated in FIG. 5, the FEC coding rate R of the transmission packet transmitted by the communication apparatus 1 is changed in the range of 7/15 to 7/7. In this case, the number of the information packets (information symbols) among the packets (symbols) transmitted to the first communication path 3A is not changed but is fixed at 7. The number of check packets (check symbols) is changed in the range of 0 to 8.

Since data that the reception side requires is the information packet, in the embodiment, as described above, the number of check packets is changed. However, the information packet may be varied, and the total sum of the information packets and the check packets, may be changed, which is equal to or greater than the number of information packets, in the range of 7 to 15.

Further, the number of packets for which the packet loss is confirmed from the transmission time of the transmission packet, that is, the number of packets (symbols) that is not transmitted to the first communication path 3A becomes 0 at minimum when the FEC coding rate R of the transmission packet is 7/15 and becomes 8 at maximum when the FEC coding rate R is 7/7. Accordingly, the number of packets (the number of symbols) which are transmitted to the first communication path 3A and permit the occurrence of the packet error becomes 0 at minimum in the case of R=7/7 and becomes 8 at maximum in the case of R=7/15.

The FEC decoder 202 performs the FEC decoding of the received packet by any one of the first FEC decoding process and the second FEC decoding process to be described later.

The first FEC decoding process starts the erasure correction for which the number of error symbols P of RS(15, 7) is P=8 at a time point where the total number of symbols (received symbols) of the same RS code that is included in the received packet normally received by the reception processor 201 becomes equal to the number of information symbols (here, 7) of the RS code. If the total number of the received symbols cannot reach the number of the information symbols, the FEC decoder 202 determines that the received symbol cannot be decoded.

The second FEC decoding process starts any one of erasure corrections in which the number of error symbols P of RS(15, 7) is 0 to 8 according to the number of the received symbols of the current RS code when the received symbols of the next RS code that are subsequent to the received symbols of the current RS code received by the reception processor 201 is received. For example, if the number of the received symbols of the current RS code is 10, the erasure correction in which the number of error symbols P of RS(15, 7) is 5 is performed. If the total number of the received packets of the current received RS code does not reach the number of information symbols of the RS code, the FEC decoder 202 determines that the received symbols cannot be decoded.

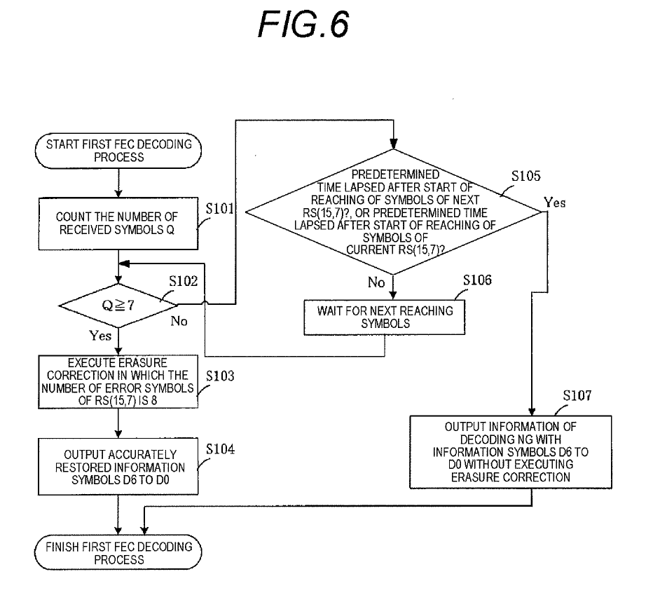

FIG. 6 is a flowchart illustrating an example of an operation when the FEC decoder 202 performs the first FEC decoding process.

First, the FEC decoder 202 counts the number of symbols Q (the number of received symbols Q) of the predetermined RS code included in the received packet, which could be normally received from the first communication path 3A received by the reception processor 201 (step S101). Then, the FEC decoder 202 determines whether the number of the received symbols Q reaches the number of information symbols (here, 7) of the RS code (step S102). If it is determined that the number of the received symbols Q reaches 7, the FEC decoder 202 assumes that the number of the received symbols is equal to the number of symbols (here, 15) when the FEC encoder 103 of the communication apparatus 1 generates the generation packet that corresponds to the received packet, and performs the erasure correction in which the number of the error symbols P of RS(15, 7) is 8 (step S103). Further, the FEC decoder 202 sends the information packets D₀ to D₆ which are accurately restored by the erasure correction to the packet analyzer 203 (step S104).

In this case, if the number of the received symbols does not reach 7, the FEC decoder 202 determines whether a predetermined time (for example, time for two reception periods of the packet) elapses after the received symbols of the next RS code are received by the reception processor 201, or whether a predetermined time elapses from the start of the reception of the received symbols of the current RS code (step S105). In the case where the predetermined time does not elapse after the received symbols of the next RS code is received and the predetermined time does not elapse from the start of reception of the received symbols of the current RS code, the FEC decoder 202 continues the reception of the packet through the reception processor 201, waits for the arrival of the next symbol (step S 106), and returns to step S102. On the other hand, in the case where the predetermined time elapses from the reception of the symbol of the next RS code or the predetermined time elapses from the start of reception of the received symbols of the current RS code, the FEC decoder 202 does not perform the erasure correction, and sends information to the effect that the FEC decoding is impossible to the packet analyzer 203 together with the information packets D₀ to D₆ (step S107).

According to the first FEC decoding processing as described above, the erasure correction can be limited to one kind (here, only the erasure correction in which the number of lost symbols of RS(15, 7) is P=8), and thus the program or signal processing circuit can be simplified. Further, since the erasure correction immediately starts when the arrival of a predetermined number of received symbols is detected, the timing of starting the erasure correction becomes earlier on average, and thus it is possible to reduce the average processing delay time.

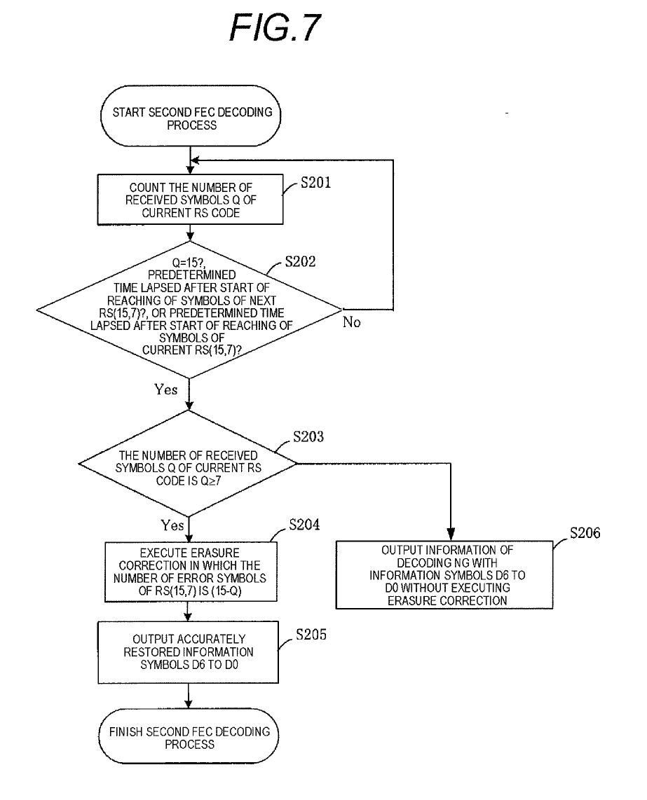

FIG. 7 is a flowchart illustrating an example of an operation when the FEC decoder 202 performs the second FEC decoding process.

First, the FEC decoder 202 counts the number of received symbols Q which could be normally received from the first communication path 3A received by the reception processor 201 (step S201). Then, the FEC decoder 202 determines whether the number of received symbols Q received by the reception processor 201 becomes the number of all the transmitted symbols (here, 15), whether the predetermined time elapses after the symbols of the next RS code are received, or whether the predetermined time elapses from the start of reception of the received symbols of the current RS code (step S202). If the number of received symbols Q is not 15, the predetermined time does not elapse after the symbols of the next RS code are received, and the predetermined time does not elapse from the start of reception of the received symbols of the current RS code, the processing returns to step S201 to wait for the subsequent symbols.

In this case, if the number of received symbols Q becomes 15, the predetermined time elapses after the symbols Q of the next RS code are received, or the predetermined time elapses from the start of reception of the received symbols Q of the current RS code, the FEC decoder 202 determines whether the number of received symbols of the current RS code at that time is equal to or larger than the number of information symbols (here, 7) of the code (step S203). If the number of received symbols of the current RS code is equal to or greater than 7, the FEC decoder 202 performs the erasure correction in which the number of error symbols P of RS(15, 7) is P=(15-Q) according to the number of received symbols Q of the current RS code (step S204). For example, if the number of received symbols Q of the current RS code is 15, the FEC decoder 202 performs the erasure correction in which the number of error symbols P of RS(15, 7) is 0, and if the number of received symbols Q of the current RS code is 7, the FEC decoder 202 performs the erasure correction in which the number of error symbols P of RS(15, 7) is 8. Further, the FEC decoder 202 sends the information symbols D₀ to D₆ accurately restored by the erasure correction to the packet analyzer 203 (step S205).

In this case, if the number of symbols Q of currently received packets is less than 7, the FEC decoder 202 does not perform the erasure correction since it cannot restore the packet loss, and sends the information to the effect that FEC decoding is impossible to the packet analyzer 203 together with the information symbols D₀ to D₆ (step S206).

According to the second FEC decoding processing as described above, the erasure correction of the RS code of the operation amount according to the number of loss packets can be performed. That is, since in accordance with the number of loss packets, a matrix with P rows and P columns represented in Equation 10, which is used for the erasure correction, differs according to the value of the number of error symbols P, the operation amount for obtaining the error symbols represented in Equation 10 differs greatly. That is, as the number of error symbols becomes less, the operation amount of the determinant that is used for the erasure correction becomes smaller. Accordingly, according to the second FEC decoding process, the time required for the erasure correction itself can be shortened on average.

According to the communication system in the embodiment as described above, a plurality of coding rates can be obtained from one generating polynomial G(x), and it is sufficient if the generating polynomial G(x) is minimally prepared during the encoding of the FEC code, and it is possible to perform flexible erasure correction according to the state of the communication path. Further, by extending the FEC coding rate R of the transmission packet at maximum, the amount of packet transmitted to the communication path 3 can be prevented to the minimum amount.

That is, B check packets are generated from A information packets, according to the state of the communication path, and x information packets and y check packets are transmitted to satisfy a condition of A≦x+y≦A+B, so that a plurality of coding rates can be used.

Further, according to the communication system according to the embodiment, the RS code is used, and thus the operation amount during the erasure correction can be reduced even in the case of packet transmission with a large number of transmission packets. For example, in the case of receiving packets composed of 1000 RS codes as illustrated in FIG. 3, an operation without omission is necessary with respect to the first RS code, but an operation that is common to the first RS code can be omitted with respect to the second and the subsequent RS codes.

### Second Embodiment

As FEC methods (FEC encoding/FEC decoding methods) of a communication apparatus, diverse kinds of FEC methods exist in the market according to the features of the communication path to be applied. Accordingly, although a communication apparatus in the related art and a communication apparatus according to the embodiment of the invention may perform communication with each other through the communication path 3, these communication apparatuses have different FEC methods, and the FEC encoding/FEC decoding cannot be appropriately performed. Accordingly, in this embodiment of the invention, in order to make the communication between communication apparatuses having different FEC methods (FEC method 1 and FEC method 2) possible, a communication management apparatus which terminates the FEC method 1 and newly executes and outputs the FEC method 2 to the opposite communication side is disposed.

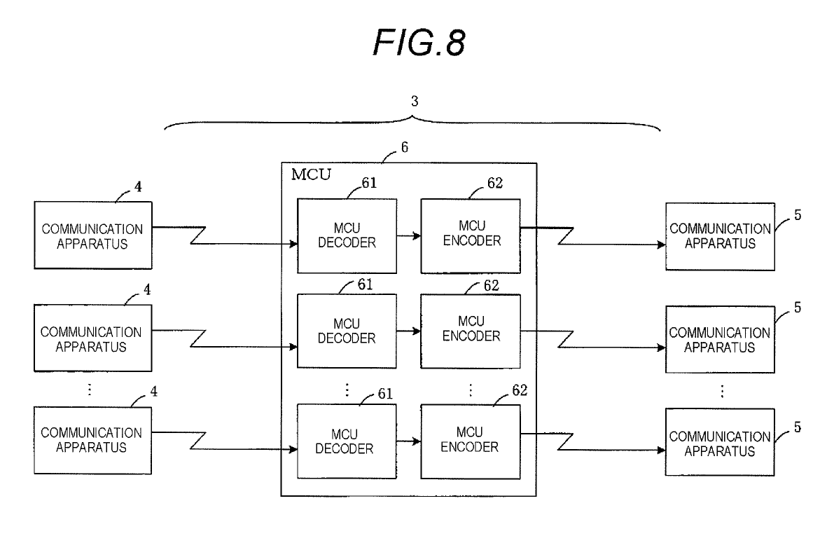

FIG. 8 is a block diagram illustrating an example of the configuration of a communication system according to a second embodiment of the invention. A communication system illustrated in FIG. 8 includes a communication apparatus 4, a communication apparatus 5, and a communication management apparatus 6. The communication apparatus 4 and the communication apparatus 5 are connected to each other through the communication path 3, and the communication management apparatus 6 is arranged on the communication path 3. In this embodiment, the communication management apparatus 6 may be a Multipoint Control Unit (MCU) that manages multipoint communication.

The communication apparatus 4 is the communication apparatus 1 or the communication apparatus 2 according to the first embodiment of the invention, and the communication apparatus 5 is a communication apparatus in the related art. The communication management apparatus 6 is provided with an MCU decoder 61 (61A, 61B, 61C, . . . ) and MCU encoder 62 (62A, 62B, 62C, . . . ). In this case, the communication apparatus 4 may be a communication apparatus in the related art, and the communication apparatus 5 may be the communication apparatus 1 or the communication apparatus 2 according to the first embodiment of the invention.

The MCU decoder 61 performs FEC decoding of a received packet from the communication path 3. The configuration and functions of the MCU decoder 61 are the same as the configuration and functions of FEC decoders 109 and 202 in the case where the communication apparatus 4 is the communication apparatus 1 or the communication apparatus 2 according to the first embodiment of the invention. Further, the FEC decoding method of the MCU decoder 61 corresponds to the FEC encoding method of communication apparatus 4.

The MCU encoder 62 performs FEC encoding of a packet that is FEC-decoded by the MCU decoder 61 in order to generate a transmission packet that is to be transmitted to the communication path 3. The configuration and functions of the MCU encoder 62 are the same as the configuration and functions of FEC encoders 103 and 210 in the case where communication apparatus 5 is the communication apparatus 1 or the communication apparatus 2 according to the first embodiment of the invention. Further, the FEC encoding method of the MCU encoder 62 corresponds to the FEC decoding method of communication apparatus 5. In this case, the FEC decoding method of the MCU decoder 61 and the FEC encoding method of the MCU encoder 62 do not correspond to each other, but differ from each other.

As described above, according to the communication system according to this embodiment of the invention, the communication management apparatus 6 that performs the FEC encoding and FEC decoding according to the respective communication apparatuses 4 and 5 in the system is provided, and the communication of an application layer between the different kinds (different makers, different FEC methods, and the like) of communication apparatuses is realized by processing functions (cloud computing) inside a network. That is, by completing the FEC encoding and FEC decoding processes between communication apparatuses 4 and 5 and communication management apparatus 6, it is possible to perform communication such as image transmission or the like between the different kinds of communication apparatuses.

### Third Embodiment

In a third embodiment of the invention, the FEC encoding and FEC decoding are realized by software modules. Accordingly, even in the case of the communication path 3 having a high packet error rate (communication path according to the cellular standard, such as High Speed Packet Access (HSPA) or Long Term Evolution (LTE)), the communication quality can be improved when the download or upload of image data is performed.

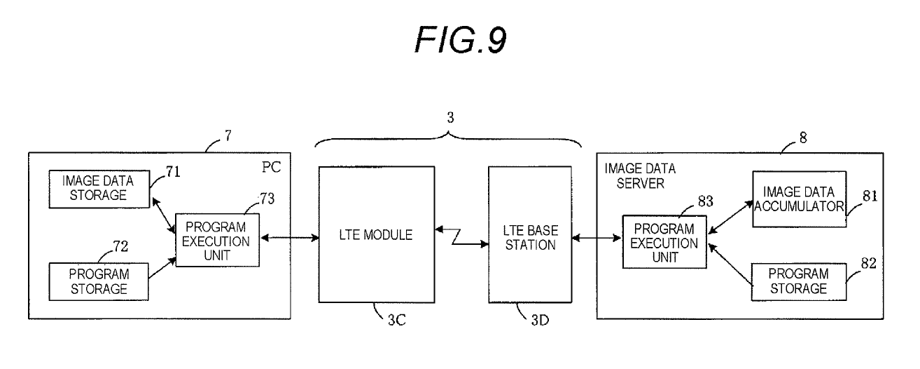

FIG. 9 is a block diagram illustrating an example of the configuration of a communication system according to a third embodiment of the invention. A communication system illustrated in FIG. 9 includes a PC 7 and an image data server 8. The PC 7 and the image data server 8 are connected to each other through the communication path 3.

The PC 7 performs processing, such as edition, search, and reading of image data, download from the image data server 8, upload to the image date server 8, and the like. The PC 7 includes an image data storage 71, a program storage 72, and a program execution unit 73. The image data storage 71 stores image encoding data (image code) that is the encoded image data. The program execution unit 73 executes the program stored in the program storage 72.

The program storage 72 stores at least one of an FEC encoding program for executing the FEC encoding of the image encoding data and an FEC decoding program for executing the FEC decoding of the image data from the communication path 3. The FEC encoding program is a program for making the computer execute respective functions of the configuration units 102 to 110 according to the first embodiment, that is, the packet generator 102, the FEC encoder 103, the transmission processor 104, the band estimator 105, the FEC coding rate determination unit 106, the channel quality estimator 107, the reception processor 108, the FEC decoder 109, and the packet analyzer 110. The FEC decoding program is a program for causing the computer to execute the respective functions of the configuration units 201 and 202 according to the first embodiment of the invention, that is, the reception processor 201 and the FEC decoder 202.

In this case, the FEC encoding program and the FEC decoding program, for example, may be acquired through the download from an external server or an external storage device, or may be prepared in the communication apparatus in advance.

The image data server 8 performs processes, such as accumulation and extraction of image data, download to each client terminal such as the

PC 7, upload from each client terminal, and the like. The image data server 8 includes an image data accumulator 81, a program storage 82, and a program execution unit 83. The image data accumulator 81 accumulates the image data or the image encoding data. The program execution unit 83 executes programs stored in the program storage 82.

The program storage 82 stores at least one of an FEC decoding program for executing the FEC decoding of the FEC-encoded image encoding data and an FEC encoding program for executing the FEC encoding of the image encoding data in which the image data that is accumulated by the image data accumulator 81 is encoded. The contents of the FEC decoding program and the FEC encoding program are the same as the contents of the program stored in the program storage 72 of the PC 7.

The communication path 3 is a communication path (LTE communication path) for performing the communication by LTE. On the communication path 3, an LTE module 3C and an LTE base station 3D are arranged. The LTE module 3C is a hardware module or a software module for realizing the LTE communication between each client terminal and the image data server 8. The LTE base station 3D has a transceiver and antennas for performing the communication between each client terminal and the image data server 8.

As described above, the communication system according to this embodiment uses the software modules called the FEC encoding program and the FEC decoding program, and thus the quality deterioration of the image data according to the communication is reduced and the communication time is shortened. That is, it is not required to perform a retransmission control several times through the TCP protocol that has been executed until the packet error is eliminated in the related art. Accordingly, even in the communication path 3 having a high packet error rate, the number of times of the retransmission control can be reduced, and thus the time required for the upload or download of the image data can be reduced. Accordingly, the image data accumulator 81 of the image data server 8 can accumulate high picture quality image data, and the PC 7 can control a display (not illustrated) to display the high picture quality image data. Further, even by the protocol that does not perform the retransmission control such as a UDP protocol, it is possible to transmit the image data with high picture quality.

In this case, the PC 7 and the image data server 8 may enable an operation unit (not illustrated) to select whether to use the FEC encoding program or the FEC decoding program.

Further, the PC 7 may perform streaming reproduction of the image data instead of downloading the image data.

In the above-described embodiments, although the communication apparatus for performing transmission/reception of the image signal has been described as an example, the communication apparatus may transmit/receive data in addition to the image signal. It is possible to provide an error correction capability to the communication apparatus through such addition of the software module.

A first aspect of the invention provides a communication apparatus for performing communication with another communication apparatus through a communication path, the communication apparatus including: an encoder which is configured to generate B number of check packets from A number of information packets; a packet transmitter which is configured to transmit x number of the information packets and y number of the check packets; and a determination unit which is configured to determine the number of the information packets and the check packets to be transmitted by the packet transmitter to satisfy a condition of A≦x+y≦A+B in accordance with a state of the communication path.

According to this communication apparatus, it is possible to reduce the amount of memory consumed since it is not necessary to prepare a large number of generating polynomials G(x).

A second aspect of the invention provides the communication apparatus, wherein the determination unit determines the number of the information packets and the check packets to be transmitted by the packet transmitter so as to satisfy a further condition of x=A, 0≦y≦B.

According to this communication apparatus, the number of check packets can be flexibly determined without reducing the number of information packets during transmission.

A third aspect of the invention provides the communication apparatus, further including a band estimator which is configured to estimate an allocable band of the communication path, wherein the determination unit determines the number of the information packets and the check packets to be transmitted by the packet transmitter in accordance with the allocable band of the communication path estimated by the band estimator.

According to this communication apparatus, the coding rate of the transmission packet can be flexibly set in consideration of the allocable band of the communication path.

A fourth aspect of the invention provides the communication apparatus, further including a channel quality estimator which is configured to estimate a channel quality of the communication path, wherein the determination unit determines the number of the information packets and the check packets to be transmitted by the packet transmitter in accordance with the channel quality of the communication path estimated by the channel quality estimator.

According to this communication apparatus, the coding rate of the transmission packet can be flexibly set in consideration of the channel quality of the communication path.

A fifth aspect of the invention provides the communication apparatus, wherein the channel quality estimator receives channel quality information, which indicates a channel quality of the communication path achieved when the packet transmitter transmits a packet to another communication apparatus, from the other communication apparatus through the communication path, and estimates the channel quality of the communication path in accordance with the received channel quality information.

According to this communication apparatus, the channel quality of the communication path achieved when the packet has been transmitted to another communication apparatus in the past is considered, and thus the coding rate of the transmission packet can be set more flexibly.

A sixth aspect of the invention provides a communication apparatus for performing communication with another communication apparatus through a communication path, the communication apparatus including: a packet receiver which is configured to receive information packets and check packets; a packet number counter which is configured to count the number of the information packets and the check packets received by the packet receiver; and a decoder which is configured to perform erasure correction with respect to the information packets received by the packet receiver if the number of the packets counted by the packet number counter is equal to or larger than the number of the information packets that are used when the check packets are generated.

According to this communication apparatus, it is possible to perform a flexible error correction regardless of the number of received packets.

A seventh aspect of the invention provides the communication apparatus, wherein the decoder performs the erasure correction when the number of the information packets and the check packets received by the packet receiver becomes equal to the number of the information packets that are used when the check packets are generated.

According to this communication apparatus, it is assumed that the number of received packets is the number of information packets during generation that is the maximum number of packets and thus the erasure correction is reliably performed.

An eighth aspect of the invention provides the communication apparatus, wherein the decoder performs the erasure correction based on the number of the information packets and the check packets which are counted by the packet number counter when the packet receiver has received next information packets and next check packets, which are subsequent to the information packets and the check packets received by the packet receiver.

According to this communication apparatus, since the erasure correction is performed according to the number of symbols of the received FEC code, the most suitable generating polynomial can be selected, and the operation process can be performed with an optimum operation amount.

A ninth aspect of the invention provides a communication method for performing communication with another communication apparatus through a communication path, the communication method including: generating B number of check packets from A number of information packets; determining x number of information packets and y number of check packets to be transmitted to satisfy a condition of A≦x+y≦A+B in accordance with a state of the communication path; and transmitting the determined number of information packets and check packets.

According to this communication method, it is possible to reduce the amount of memory consumed since it is not necessary to prepare a large number of generating polynomials G(x).

A tenth aspect of the invention provides a communication method for performing communication with another communication apparatus through a communication path, the communication method including: receiving information packets and check packets; counting the number of the received information packets and the received check packets; and performing erasure correction with respect to the received information packets if the number of counted packets is equal to or larger than the number of information packets that are used when the check packets are generated.

According to this communication method, it is possible to perform a flexible error correction regardless of the number of received packets.

An eleventh aspect of the invention provides a non-transitory storage medium in which is stored a communication program for causing a computer to execute respective steps of the communication method described in the ninth aspect of the invention.

According to this storage medium, it is possible to reduce the amount of memory consumed since it is not necessary to prepare a large number of generating polynomials G(x).

A twelfth aspect of the invention provides a non-transitory storage medium in which is stored a communication program for causing a computer to execute respective steps of the communication method described in the tenth aspect of the invention.

According to this storage medium, it is possible to perform a flexible error correction regardless of the number of received packets.

This application claims the benefit of Japanese Patent Application No. 2011-003316 filed on Jan. 11, 2011, the contents of which are incorporated herein by reference.

What is claimed is:

1. A communication apparatus for performing communication with another communication apparatus through a communication path, the communication apparatus comprising:
an encoder which is configured to generate B number of check packets from A number of information packets;
a packet transmitter which is configured to transmit x number of the information packets and y number of the check packets; and
a determination unit which is configured to determine the number of the information packets and the check packets to be transmitted by the packet transmitter to satisfy a condition of A≦x+y≦A+B in accordance with a state of the communication path.

2. The communication apparatus according to claim 1, wherein the determination unit determines the number of the information packets and the check packets to be transmitted by the packet transmitter so as to satisfy a further condition of x=A, 0≦y≦B.

3. The communication apparatus according to claim 1, further comprising
a band estimator which is configured to estimate an allocable band of the communication path, wherein
the determination unit determines the number of the information packets and the check packets to be transmitted by the packet transmitter in accordance with the allocable band of the communication path estimated by the band estimator.

4. The communication apparatus according to claim 1, further comprising
a channel quality estimator which is configured to estimate a channel quality of the communication path, wherein
the determination unit determines the number of the information packets and the check packets to be transmitted by the packet transmitter in accordance with the channel quality of the communication path estimated by the channel quality estimator.

5. The communication apparatus according to claim 4, wherein
the channel quality estimator receives channel quality information, which indicates a channel quality of the communication path achieved when the packet transmitter transmits a packet to another communication apparatus, from the other communication apparatus through the communication path, and estimates the channel quality of the communication path in accordance with the received channel quality information.

6. A communication apparatus for performing communication with another communication apparatus through a communication path, the communication apparatus comprising:
a packet receiver which is configured to receive information packets and check packets;
a packet number counter which is configured to count the number of the information packets and the check packets received by the packet receiver; and
a decoder which is configured to perform erasure correction with respect to the information packets received by the packet receiver if the number of the packets counted by the packet number counter is equal to or larger than the number of the information packets that are used when the check packets are generated.

7. The communication apparatus according to claim 6, wherein
the decoder performs the erasure correction when the number of the information packets and the check packets received by the packet receiver becomes equal to the number of the information packets that are used when the check packets are generated.

8. The communication apparatus according to claim 6, wherein
the decoder performs the erasure correction based on the number of the information packets and the check packets which are counted by the packet number counter when the packet receiver has received next information packets and next check packets, which are subsequent to the information packets and the check packets received by the packet receiver.

9. A communication method for performing communication with another communication apparatus through a communication path, the communication method comprising:
generating B number of check packets from A number of information packets;
determining x number of information packets and y number of check packets to be transmitted to satisfy a condition of A≦x+y≦A+B in accordance with a state of the communication path; and
transmitting the determined number of information packets and check packets.

10. A communication method for performing communication with another communication apparatus through a communication path, the communication method comprising:
receiving information packets and check packets;
counting the number of the received information packets and the received check packets; and
performing erasure correction with respect to the received information packets if the number of counted packets is equal to or larger than the number of information packets that are used when the check packets are generated.

11. A non-transitory storage medium in which is stored a communication program for causing a computer to execute respective steps of the communication method described in claim 9.

12. A non-transitory storage medium in which is stored a communication program for causing a computer to execute respective steps of the communication method described in claim 10.
